(19) United States
(12) Patent Application Publication
(10) Pub. No.: US 2025/0148408 A1
(43) Pub. Date: May 8, 2025

(54) METHODS AND SYSTEMS FOR TRACKING MAILED ITEMS BASED ON HASH VALUES

(71) Applicant: United States Postal Service, Washington, DC (US)

(72) Inventors: Jeffrey J. Tackes, Washington, DC (US); Clayton Bonnell, Washington, DC (US)

(21) Appl. No.: 18/934,659

(22) Filed: Nov. 1, 2024

Related U.S. Application Data
(60) Provisional application No. 63/597,261, filed on Nov. 8, 2023.
(60) Provisional application No. 63/597,260, filed on Nov. 8, 2023.

(51) Int. Cl. G06Q 10/0833; H04L 9/32

(52) U.S. Cl. CPC G06Q 10/0833; H04L 9/3236

(57) ABSTRACT

Systems and methods for tracking a mailed item contained in a mail piece mailed by a user are disclosed. In some embodiments, a disclosed method comprises: capturing, using a camera on a mobile device, an item picture of the mailed item; generating an item hash value using a hash function on the item picture; capturing, using the camera on the mobile device, a mail picture of a front side of the mail piece containing the mailed item, one or more marks being put by the user in at least one specified zone on the front side of the mail piece when the mail picture is taken; generating a mail hash value using the hash function on the mail picture; transmitting the item hash value, the mail hash value and a user identity (ID) of the user to a mail service computing device associated with a mail service configured for carrying and delivering the mail piece; and tracking the mailed item in the mail piece by monitoring one or more notifications regarding delivery status information of the mail piece from the mail service computing device.

### CROSS-REFERENCE TO RELATED APPLICATIONS

This application claims the benefit of U.S. Provisional Application No. 63/597,261 filed Nov. 8, 2023 and of U.S. Provisional Application No. 63/597,260, filed Nov. 8, 2023, each of which is incorporated herein by reference in its entirety.

### TECHNICAL FIELD

This application relates, generally, to mail tracking and, in particular, to tracking a mailed item contained in a mail piece mailed by a user based on hash values.

### BACKGROUND

While a postage stamp can give a user access to the postal network, buying stamps and having them on hand when desired is less and less common, given the number of other non-postal methods for paying bills, sending greeting cards or invitations, etc. Mailing a letter or package becomes difficult for customers who are busy, having no stamp, and far from mail offices or postal services.

In addition, customers currently have very few methods to track the delivery status of mail pieces, e.g. letters, birthday cards, post cards, utility bills, charitable donations, invitations, etc. Without paying extra money for high-end tracking services or without access to a delivery service office, customers today cannot track the mail pieces or mailed items, after putting them into a mailbox.

Further, mail theft from collection boxes and personal mailboxes has increased significantly over the past few years. Criminals steal mail containing checks, alter the payee and amount, and cash them. The original payee and amounts are “washed” away, and replaced by a new payee and amount of the criminal's choice. For example, a customer mailing a check for a simple $35 utility bill may be shocked to see $4,999 stolen from her checking account. This has resulted in lack of confidence in using mail for bill payment and other financial transactions, ranging from small gift checks to utility bills, to large charitable donations and to vendor invoices.

### SUMMARY

The present teaching is directed to systems and methods for tracking a mailed item contained in a mail piece mailed by a user based on hash values.

In one embodiment, a method, implemented on a device including at least one processor and a non-transitory memory, for tracking a mailed item contained in a mail piece mailed by a user is disclosed. The method comprises: capturing, using a camera on a mobile device, an item picture of the mailed item; generating an item hash value using a hash function on the item picture; capturing, using the camera on the mobile device, a mail picture of a front side of the mail piece containing the mailed item, one or more marks being put by the user in at least one specified zone on the front side of the mail piece when the mail picture is taken; generating a mail hash value using the hash function on the mail picture; transmitting the item hash value, the mail hash value and a user identity (ID) of the user to a mail service computing device associated with a mail service configured for carrying and delivering the mail piece; and tracking the mailed item in the mail piece by monitoring one or more notifications regarding delivery status information of the mail piece from the mail service computing device. The one or more notifications regarding delivery status information of the mail piece are generated based on (i) one or more comparisons of the item hash value to other item hash values for other mail pieces, (ii) one or more comparisons of the mail hash value to other mail hash values for other mail pieces and (iii) the user ID.

In another embodiment, a system for tracking a mailed item contained in a mail piece mailed by a user is disclosed. The system comprises: a non-transitory memory having instructions stored thereon; and at least one processor operatively coupled to the non-transitory memory. The at least one processor is configured to read the instructions to: capture, using a camera on the mobile device, an item picture of the mailed item; generate an item hash value using a hash function on the item picture; capture, using the camera on the mobile device, a mail picture of a front side of the mail piece containing the mailed item, wherein one or more marks are put by the user in at least one specified zone on the front side of the mail piece when the mail picture is taken; generate a mail hash value using the hash function on the mail picture; transmit the item hash value, the mail hash value and a user identity (ID) of the user to a mail service computing device associated with a mail service configured for carrying and delivering the mail piece; and track the mailed item in the mail piece by monitoring one or more notifications regarding delivery status information of the mail piece from the mail service computing device. The one or more notifications regarding delivery status information of the mail piece are generated based on (i) one or more comparisons of the item hash value to other item hash values for other mail pieces, (ii) one or more comparisons of the mail hash value to other mail hash values for other mail pieces and (iii) the user ID.

In a different embodiment, a non-transitory computer readable medium having instructions stored thereon for tracking a mailed item contained in a mail piece mailed by a user is disclosed. The instructions, when executed by at least one processor, cause the at least one processor to perform operations comprising: capturing, using a camera on a mobile device, an item picture of the mailed item; generating an item hash value using a hash function on the item picture; capturing, using the camera on the mobile device, a mail picture of a front side of the mail piece containing the mailed item, one or more marks being put by the user in at least one specified zone on the front side of the mail piece when the mail picture is taken; generating a mail hash value using the hash function on the mail picture; transmitting the item hash value, the mail hash value and a user identity (ID) of the user to a mail service computing device associated with a mail service configured for carrying and delivering the mail piece; and tracking the mailed item in the mail piece by monitoring one or more notifications regarding delivery status information of the mail piece from the mail service computing device. The one or more notifications regarding delivery status information of the mail piece are generated based on (i) one or more comparisons of the item hash value to other item hash values for other mail pieces, (ii) one or more comparisons of the mail hash value to other mail hash values for other mail pieces and (iii) the user ID.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the present teaching. In the following description, various embodiments of the present teaching are described with reference to the following drawings, in which:

FIG. 1 is a network environment configured to track mail pieces and mailed items based on hash values, in accordance with some embodiments of the present teaching;

FIG. 2 is a block diagram of a mail tracking device, in accordance with some embodiments of the present teaching;

FIG. 3 is a block diagram illustrating various portions of a mail processing system, in accordance with some embodiments of the present teaching;

FIG. 4 illustrates exemplary portions of a database for tracking mail pieces and mailed items, in accordance with some embodiments of the present teaching;

FIG. 5 illustrates a front side of an exemplary mail piece to be tracked, in accordance with some embodiments of the present teaching;

FIGS. 6A and 6B illustrate an exemplary process for tracking a mail piece based on hash values, in accordance with some embodiments of the present teaching;

FIG. 7 is a flowchart illustrating an exemplary method for tracking a mail piece, in accordance with some embodiments of the present teaching;

FIG. 8 illustrates an exemplary process for tracking a mailed item based on hash values, in accordance with some embodiments of the present teaching;

FIG. 9 is a flowchart illustrating an exemplary method for tracking a mailed item, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

When a user wants to send a mail piece, e.g. a letter, a post card, a package, etc., he may have no stamp in hand, no time to go to a delivery or postal office, and no access to a label printer or stock. But at the same time, the user may just want to put the mail piece into a mailbox on street, and have a way to track the delivery status of the mail piece, especially when the mail piece contains a high or specially valued mailed item.

The present teaching discloses systems and methods for a user to track mail pieces and mailed items based on hash values, even when the user has no stamp and no access to a delivery service or postal office. In some embodiments, a disclosed system offers customers functions like paying the mailing without stamp and/or tracking the mailing. These functions are not co-dependent, which means mailing payment and tracking could be offered separately. For example, a customer uses a mobile app (e.g. an app called “Hash Tracker”) on a smartphone to uniquely mark a mail piece (e.g. on a front side of an envelope) to be mailed and take a photograph or picture of the marked mail piece. The photo would then be hashed and sent to a mail service associated with the app. The mail service would then compare that hash to other hashes of images of mail pieces it processes through normal handling of letters. By linking the hash to an identity (ID) tag of the mail piece, tracking events would be collected and made available to the customer.

In some embodiments, the Hash Tracker app leverages technologies like image lifting, ID tagging, and remote computer reading. The Hash Tracker app would benefit from a standardized hashing process or any other method for generating a hash value from an image or picture. The disclosed system using the Hash Tracker app enhances customers' confidence in mailing items using postal technology or any shipper using similar imaging technologies. For example, this is a direct enhancement to the First-Class Mail service provided by the United States Postal Service (USPS). The Hash Tracker app or service could be offered at an added cost, as an enticement to mail more often, or for other revenue generating services. With the Hash Tracker app, fewer stamps need to be printed or sold through various non-postal channels.

In some embodiments, a customer would use a mobile app (e.g. an app called “Check Tracker”) on a smartphone to take a photograph or image of a check to be mailed. The image would be hashed and stored on the customer's phone. The stored data could then be used by the customer to challenge any altered check. If desired, the customer may also opt to track the letter containing the check, e.g. using the Hash Tracker app. The Check Tracker app can link the check hash with the envelope hash as described and would be available for research and reference by authorized law enforcement and fraud investigators. In some embodiments, the image does not leave the customer's phone in any fashion and therefore not available to the mail service.

The disclosed system using the Check Tracker app provides a method to create evidence of original items and an evidentiary trail, protecting the customer, assisting law enforcement, and establishing bank liability over altered checks, thus bolstering safety and security of the mail. This is a direct enhancement to the First-Class Mail service provided by the USPS, and in response to customer concerns about the risk of loss due to mail thefts. It could be offered as an added cost, as an enticement to mail more often, or for other revenue generating services. The Check Tracker app could make mail theft of checks less desirable due to the increased visibility and evidence. In some embodiments, the Check Tracker app can help to track not only check, but also any item mailed with concern, including e.g. bills, receipt, money order, legal documents, any item with critical numerical information, or any item with a high or special value to the customer.

In some embodiments, the Hash Tracker app and the Check Tracker app may be implemented as a same app having multiple functions. A server of the app can communicate with a delivery service or mail service responsible for mailing items for the customer. A user account of the customer is created on the app, such that the customer can pay the mail service through a pre-stored payment method, e.g. credit card, debit card, or electronic transfers. After the customer mails a piece leveraging the app, the mail service can identify the customer based on a match between: (1) a first hash value of a first image of the letter uploaded to the app by the customer, and (2) a second hash value of a second image of the letter taken by a camera of the mail service. As such, the mail service can charge the customer using the pre-stored payment method, and the customer does not need to use any stamp. In addition, the mail service will send notifications of updated delivery status of the letter to the customer through the app. As such, the customer can track the letter without being physically present in any office of the mail service.

Furthermore, in the following, various embodiments are described with respect to methods and systems for tracking mail pieces and mailed items based on hash values are disclosed. In some embodiments, a disclosed method includes: obtaining an image of the mail piece; generating a hash value of the image of the mail piece; obtaining a plurality of hash values associated with a plurality of users; determining a match between the hash value and one of the plurality of hash values; identifying, based on a result of the determining a match, a user associated with mailing of the mail piece; and providing delivery status information of the mail piece to the user.

In some embodiments, a disclosed method includes: activating a camera on the device to take a first picture of the mailed item; applying a hash function to the first picture to generate a first hash value; instructing the user to put handwriting in at least one specified zone on a front side of a mail piece containing the mailed item; activating the camera on the device to take a second picture of the front side of the mail piece; and applying the hash function to the second picture to generate a second hash value.

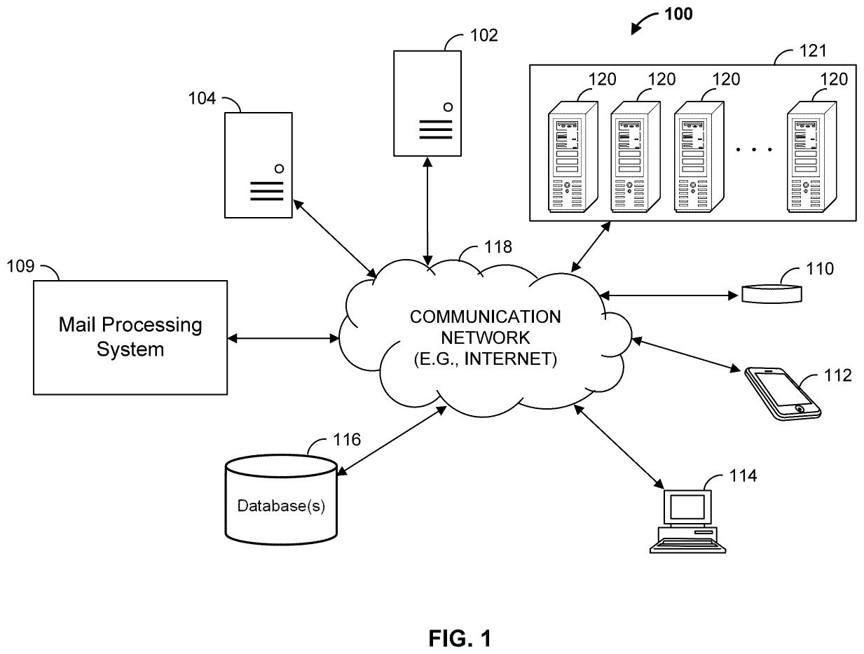

Turning to the drawings, FIG. 1 is a network environment 100 configured to track mail pieces and mailed items based on hash values, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a mail tracking device 102 (e.g., a server associated with one or more delivery or mail services), a server 104 (e.g. an app server), a cloud-based engine 121 including one or more processing devices 120, a mail processing system 109, a database 116, and one or more user computing devices 110, 112, 114 operatively coupled over the network 118. One or more of the mail tracking device 102, the server 104, the mail processing system 109, the processing device(s) 120, and the multiple user computing devices 110, 112, 114 can be any suitable computing device that includes any hardware or hardware and software combination for processing and handling information. For example, one or more of these devices, servers, and systems can include one or more processors, one or more field-programmable gate arrays (FPGAs), one or more application-specific integrated circuits (ASICs), one or more state machines, digital circuitry, or any other suitable circuitry, and can transmit and receive data over the communication network 118.

In some examples, each of the mail tracking device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the mail tracking device 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the server 104 hosts an app or software that delivers an application through a communication protocol to provide services, e.g. mailing services. In some examples, the mail tracking device 102, the processing devices 120, and/or the server 104 are operated by a mail service company. The multiple user computing devices 110, 112, 114 may be operated by customers or users associated with the app. In some examples, the processing devices 120 are operated by a third party (e.g., a cloud-computing provider).

The mail processing system 109 is operably coupled to the communication network 118, e.g. via a router (or switch). The mail processing system 109 may be located at a postal office or any mail service office. The mail processing system 109 can communicate with the mail tracking device 102 over the communication network 118. The mail processing system 109 may send data to, and receive data from, the mail tracking device 102. For example, the mail processing system 109 may transmit an image of a letter to the mail tracking device 102 for identifying a customer mailing the letter.

Although FIG. 1 illustrates three user computing devices 110, 112, 114, the network environment 100 can include any number of user computing devices 110, 112, 114. Similarly, the network environment 100 can include any number of the mail tracking devices 102, the processing devices 120, the mail processing systems 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple computing devices 110, 112, 114 may be operable to view, access, and interact with an app, e.g. a mail service app hosted by the server 104. The server 104 may transmit user account information (e.g. payment method) and mail tracking information (e.g. hash values generated from mail images) to the mail processing system 109 and/or the mail tracking device 102.

In some examples, a customer may operate one of the user computing devices 110, 112, 114 to log into an app served by the server 104, for sending a mail piece, e.g. a letter, via a mail service. The customer may, via the app, view functions and services provided by the mail service, and choose a corresponding function to proceed. The app allows the customer to create a user account, and store user information, home address and/or some payment methods associated with the user account. The customer can pay the mail service using a pre-stored payment method, without using any stamp (e.g., without affixing a pre-paid stamp to the mail piece). The app may provide a mail tracking service to the customer, for tracking the mail piece based on a hash value generated from an image of the mail piece. For example, the app instructs the customer to hand write or print some specific or unique mark on the mail piece such as a letter and take a picture of the marked letter. The app can generate a hash value of the picture and store the hash value on the user computing device of the customer. In addition, the user computing device can share the hash value with the server 104, which may further transmit the hash value to the mail service for tracking the letter. For example, the server 104 may send the hash value in association with the customer's user ID to the mail tracking device 102, the mail processing system 109, and/or the database 116.

In some embodiments, the mail tracking device 102 may obtain, e.g. via the server 104 or a database associated with the server 104, a plurality of hash values generated from images of mail pieces, including the hash value of the letter picture of the customer. In addition, while the letter is being processed by the mail processing system 109, an additional picture of the letter is taken by a camera in the mail processing system 109 and the additional picture is provided to the mail tracking device 102. Based on the additional picture, the mail tracking device 102 may generate a candidate hash value and compare the candidate hash value with the plurality of hash values to determine whether there is a match. In this example, the mail tracking device 102 would determine a match between the candidate hash value and the hash value of the letter picture of the customer. As such, the mail tracking device 102 can identify the customer by the user ID associated with the hash value of the letter picture of the customer, and allow the mail service to charge the customer based on some pre-stored payment method.

In addition, the mail processing system 109 may attach or spray an ID tag on the letter, in association with the candidate hash value. After the mail tracking device 102 identifies the customer who mailed the letter, the letter will be tracked based on the ID tag to determine updated delivery status, which may be sent as notifications to the customer via the app.

Each of the mail tracking device 102, the server 104 and the mail processing system 109 is operable to communicate with the database 116 over the communication network 118, and can store data to and read data from the database 116. For example, the server 104 can store hash values generated by the app in the database 116; the mail tracking device 102 can read hash values stored in the app; and the mail processing system 109 may update delivery event data in the database 116. The database 116 can be a remote storage device, such as a cloud-based server, a disk (e.g., a hard disk), a memory device on another application server, a networked computer, or any other suitable remote storage. Although shown remote to the mail tracking device 102, the server 104 and the mail processing system 109, in some examples, the database 116 or some sub-database in the database 116 can be a local storage device, such as a hard drive, a non-volatile memory, or a USB stick of the mail tracking device 102, the server 104 or the mail processing system 109.

In some examples, the mail tracking device 102 may execute one or more models (e.g., algorithms), such as a machine learning model, deep learning model, statistical model, etc., to track mail pieces. For example, the mail tracking device 102 may use a machine learning model to generate a hash value of an image of a mail piece. The models, when executed by the mail tracking device 102, allow the mail tracking device 102 to generate accurate hash values and distinguish pictures of different mail pieces based on different corresponding hash values. In some examples, the mail tracking device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the mail tracking device 102 may generate hash values for tracking mail pieces.

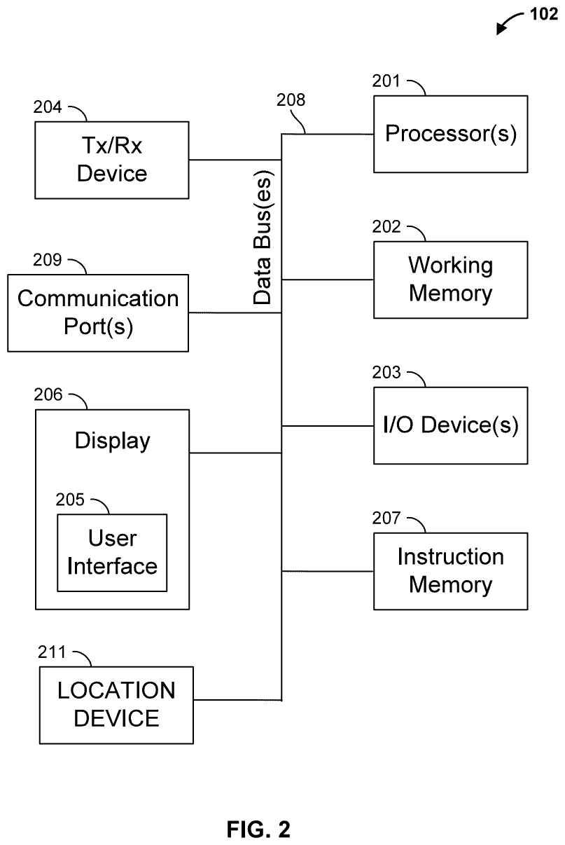

FIG. 2 illustrates a block diagram of a mail tracking device, e.g. the mail tracking device 102 of FIG. 1, in accordance with some embodiments of the present teaching. In some embodiments, each of the mail tracking device 102, the server 104, the mail processing system 109, the multiple user computing devices 110, 112, 114, and the one or more processing devices 120 in FIG. 1 may include the features shown in FIG. 2. Although FIG. 2 is described with respect to certain components shown therein, it will be appreciated that the elements of the mail tracking device 102 can be combined, omitted, and/or replicated. In addition, it will be appreciated that additional elements other than those illustrated in FIG. 2 can be added to the mail tracking device 102.

As shown in FIG. 2, the mail tracking device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the mail tracking device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the mail tracking device 102 can include a single memory unit configured to operate as both instruction memory and working memory. Further, although embodiments are discussed herein including non-volatile memory, it will be appreciated that the mail tracking device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the mail tracking device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the mail tracking device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the mail tracking device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the mail tracking device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the mail tracking device 102 may determine a local geographical area (e.g., town, city, state, etc.) of its position.

In some embodiments, the mail tracking device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

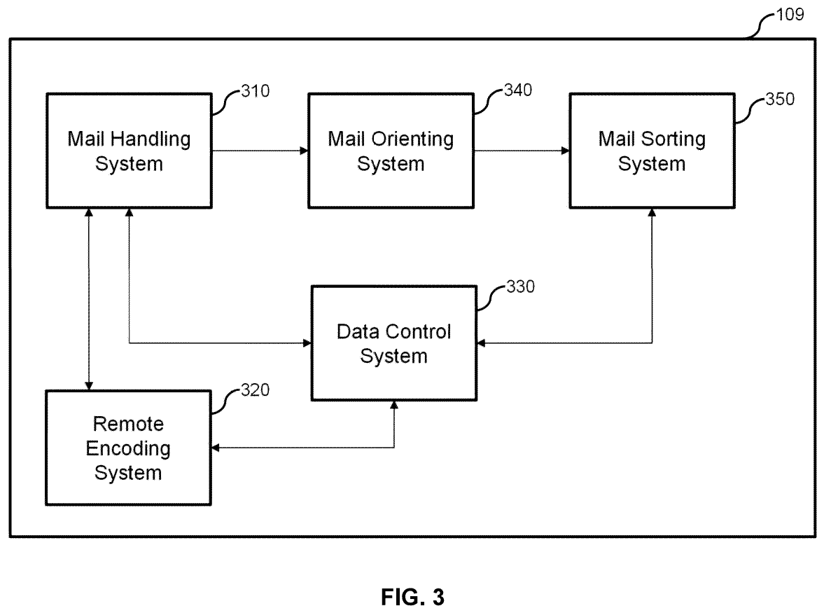

FIG. 3 is a block diagram illustrating various portions of a mail processing system 109, in accordance with some embodiments of the present teaching. In some embodiments, the mail processing system 109 in FIG. 3 may be implemented as the mail processing system 109 in FIG. 1. As shown in FIG. 3, the mail processing system 109 in this example includes a mail handling system 310, a remote encoding system 320, a data control system 330, an optional mail orienting system 340, and a mail sorting system 350. The data control system 330 is connected to the mail handling system 310, the mail sorting system 350, and the remote encoding system 320. The data control system 330 organizes bar code information and mail identifiers. The data control system 330 includes a processor and memory with a bar code database. In some embodiments, the mail processing system 109 is operated by a postal service or delivery device.

In some embodiments, the mail handling system 310 places incoming mail into a single file line in a pinch belt, checks for appropriate postage on mail, cancels the postage, and/or places the mail in stackers. The mail handling system 310 positions the mail upright between a pair of pinch belts with either the stamp leading and the address on the front side or the stamp trailing and the address on the back side. The mail handling system 310 obtains a picture image of each piece of mail and prints a mail identifier on each mail piece that is stored along with the image. The image is used to determine mail type such as printed address and script address. After canceling the postage, the mail handling system 310 sorts the mail into one or more bins based on mail type. Each mail type has two bins, one for mail with the stamp leading and one for mail with the stamp trailing.

In some embodiments, the image obtained by the mail handling system 310 can be used by the mail tracking device 102 to identify a customer who is requesting tracking service for the corresponding mail piece. In some embodiments, the mail handling system 310 is an advanced facer-canceler system (AFCS).

In some embodiments, the mail handling system 310 checks for postage stamp on received mail and put a cancellation mark on the stamp when stamp is found. When stamp is not found, the mail handling system 310 may send the image of the mail piece to the mail tracking device 102 to determine whether a user account can be identified based on a hash value of the image, and whether a payment method can be found and executed for the identified user account, e.g., to charge an amount equal to the stamp value needed to complete the intended delivery of the mail piece.

In some embodiments, the mail handling system 310 also prints a mail piece identifier, e.g. an ID tag, on each piece of mail. In some embodiments, bar codes on the mail indicate the destination of the mail piece. The mail handling system 310 determines if a mail piece already contains a bar code and, if so, forwards the mail piece to the mail orienting system 340 or directly to the mail sorting system 350. A mail piece that does not have a bar code is processed by an optical character reader (OCR) located within the mail handling system 310. The OCR attempts to analyze address information from an optical image of the mail piece, obtained by the mail handling system 310, to generate bar code data for the mail piece. If the OCR is not able to decode an address, the image of the mail piece is sent to the remote encoding system 320, where individuals located at the remote encoding system 320 view the image of the mail piece and input bar code information. The bar code information determined by the OCR or input at the remote encoding system 320 is forwarded to the data control system 330 for storage in a bar code database along with the mail piece identifier. The bar code database may be a standalone database local to the data control system 330, or a sub-database within the database 116.

In some embodiments, the mail handling system 310 outputs mail to the mail orienting system 340, which places all mail pieces in the same orientation, such as stamp leading, and carries the mail over a work area and back down to enter the mail sorting system 350. In some embodiments, the mail orienting system 340 includes a camera configured to take a picture of each mail piece in the same orientation. The pictures of mail pieces in the same orientation are sent to the mail tracking device 102 for generating hash values to be compared with stored hash values.

In some embodiments, the mail sorting system 350 accepts mail from the mail orienting system 340 and prints bar codes on mail when needed. The mail sorting system 350 sorts the mail into a plurality of stackers based on the bar code data which reflects the mail destination. In some embodiments, the mail sorting system 350 directs mails into a plurality of stackers based on the destination indicated on a bar code on a mail piece. The mail sorting system 350 determines if a mail piece has a bar code. The mail sorting system 350 uses the bar code to direct the mail piece to a stacker associated with the destination. If a mail piece does not have a bar code, the mail sorting system 350 queries the bar code database at the data control system 330 using the mail piece identifier, requesting bar code information. If bar code information is in the bar code database, the mail sorting system 350 receives the bar code information from the data control system 330, prints the bar code on the mail piece and directs the mail to the appropriate destination stacker. Otherwise, the mail is placed in a reject stacker. The rejected pieces may be re-run through the mail sorting system 350 at a later time after the remote encoding system 320 has entered more bar code data into the bar code database. In some embodiments, the mail sorting system 350 is a delivery bar code sorter (DBCS).

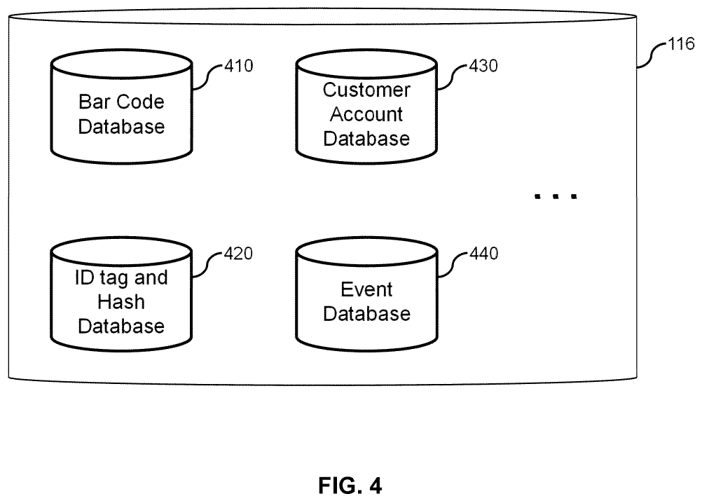

FIG. 4 illustrates exemplary portions of a database, e.g. the database 116 in FIG. 1, for tracking mail pieces and mailed items, in accordance with some embodiments of the present teaching. As shown in FIG. 4, the database 116 includes a bar code database 410, an ID tag and hash database 420, a customer account database 430, and an event database 440. In some embodiments, the bar code database 410 is a database storing bar code for the data control system 330 in FIG. 3.

In some embodiments, the ID tag and hash database 420 stores associated ID tag and hash values. That is, the ID tag and hash database 420 can store a plurality of ID-hash pairs, each of which includes a corresponding ID tag and a corresponding hash value associated with each other. The corresponding hash value may be generated from an image of a mail piece taken by the mail handling system 310 or the mail orienting system 340 in FIG. 3. The corresponding ID tag may be a mail piece identifier generated by the mail handling system 310, or any ID mark that can be applied on the mail piece to identify the mail piece specifically or uniquely. In some embodiments, while the image is taken from a front side of the mail piece, the corresponding ID tag is applied to a back side of the mail piece.

In some embodiments, the customer account database 430 stores customer account information. For example, the customer account database 430 may store information of a user account of a customer, e.g. the customer's user ID on the app, pre-stored payment method, pre-stored name and home address, usage history of the app and the mail service, transaction history on via the app, pre-stored contact information for receiving notifications, etc.

In some embodiments, the event database 440 stores delivery event information. For example, the event database 440 may store event information of a delivery status of a mail piece, e.g. the past locations of the mail piece, when did the mail piece arrive at each of the past locations, whether the mail piece is delivered, delivery time, expected delivery time, and any other delivery status information of the mail piece.

In some embodiments, the database 116 may include additional databases. In some embodiments, all the databases in the database 116 may be cross-indexed to each other for data retrieval. In some embodiments, each of the bar code database 410, the ID tag and hash database 420, the customer account database 430 and the event database 440 may be a standalone database, or a local database to the mail tracking device 102, the server 104, or the mail processing system 109.

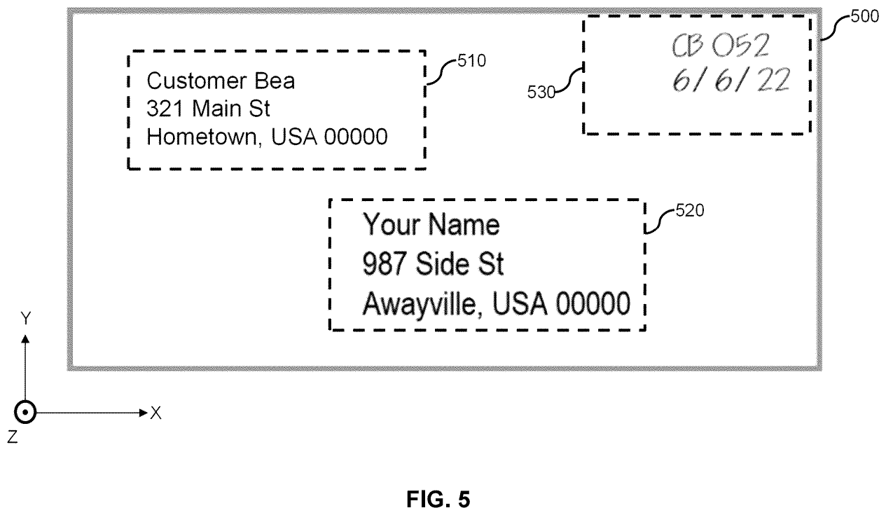

FIG. 5 illustrates a front side of an exemplary mail piece 500 to be tracked, in accordance with some embodiments of the present teaching. In some embodiments, the mail piece 500 is a mail piece as described in the present teaching referring to any other figure.

As shown in FIG. 5, the mail piece 500 includes different zones: a sender address zone 510 at an upper left corner of the front side of the mail piece 500, a recipient address zone 520 at a lower center of the front side of the mail piece 500, and a stamp zone 530 at an upper right corner of the front side of the mail piece 500. As such, a stamp leading direction in FIG. 5 is the direction X.

In this example, a customer called “Customer Bea” is sending the mail piece 500. Customer Bea is instructed to put her name and address in the sender address zone 510, and to put the recipient's name and address in the recipient address zone 520. In some embodiments, Customer Bea is instructed to put a stamp in the stamp zone 530 before mailing the mail piece 500, e.g., when customer account underfunded, or hashing service unavailable due to maintenance.

In some embodiments, as shown in FIG. 5, Customer Bea is instructed to write or print certain one or more marks in the stamp zone 530, instead of putting any stamp on the mail piece 500. The marks are preferred to be hand written or printed and unique or specific enough to generate hash value distinguishable from other hash values of other mail pictures. In this case, when a system, e.g. the mail handling system 310, determines that no postage is detected in the stamp zone 530, the system does not reject the mail piece directly. Instead, the system sends a picture of the front side of the mail piece 500 to the Remote Encoding System 320 to generate a hash value and try to match by comparing the hash value generated by the mail tracking device 102 with stored hash values received from an app, e.g., a Hash Tracker app or a Check Tracker app, which identifies the user account of Customer Bea.

In some embodiments, all hash values generated by the mail tracking device 102 and the app are based on images of mail pieces put in a same orientation (including same direction and rotation), e.g. the orientation of the mail piece 500 in FIG. 5. In some embodiments, the hash value of the mail piece 500 is generated based on an entirety of the picture of the front side of the mail piece 500. In some embodiments, the hash value of the mail piece 500 is generated based on merely the sender address zone 510, the recipient address zone 520 and the stamp zone 530 in the picture of the front side of the mail piece 500. In some embodiments, the hash value of the mail piece 500 is generated based on merely the stamp zone 530 in the picture of the front side of the mail piece 500. In some embodiments, the hash value of the mail piece 500 is generated based on not only these picture zones of the mail piece 500, but also other attributes related to the picture, including but not limited to: dimension, color, shape of the mail piece 500, language of the text in the zones, etc., which can be obtained and identified using a camera system on the user device as well as in the mail tracking device.

In some embodiments, the boundaries of the sender address zone 510, the recipient address zone 520 and the stamp zone 530 are pre-determined based on the dimensionality of the mail piece 500. In some embodiments, the boundaries of the sender address zone 510, the recipient address zone 520 and the stamp zone 530 are determined based on relative locations of the characters applied on the front side of the mail piece 500. In some embodiments, the boundaries of the sender address zone 510, the recipient address zone 520 and the stamp zone 530 are determined by detecting the first pixel and the last pixel containing characters or writings in each zone.

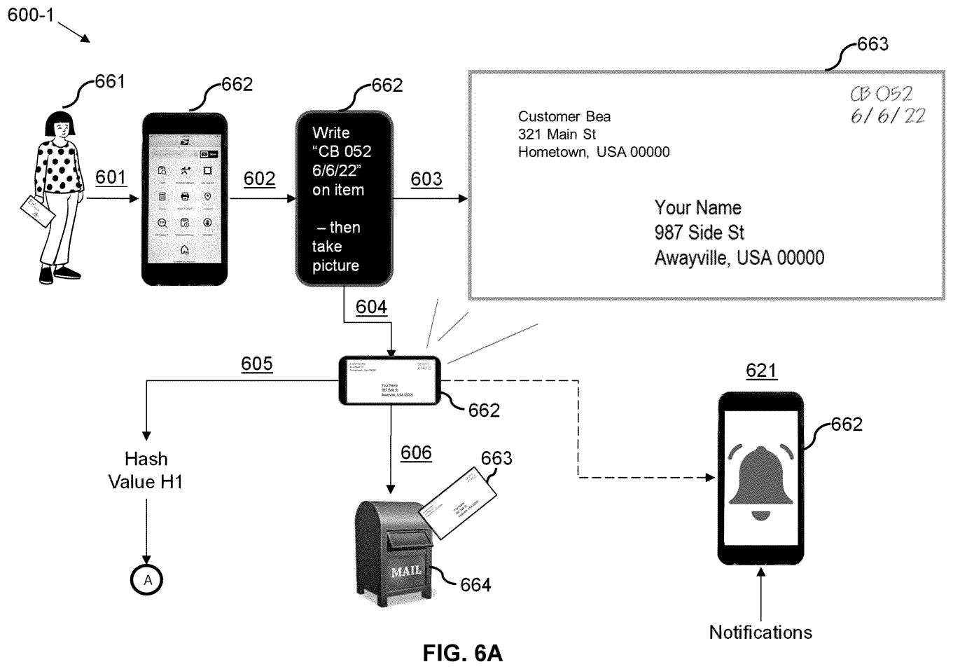

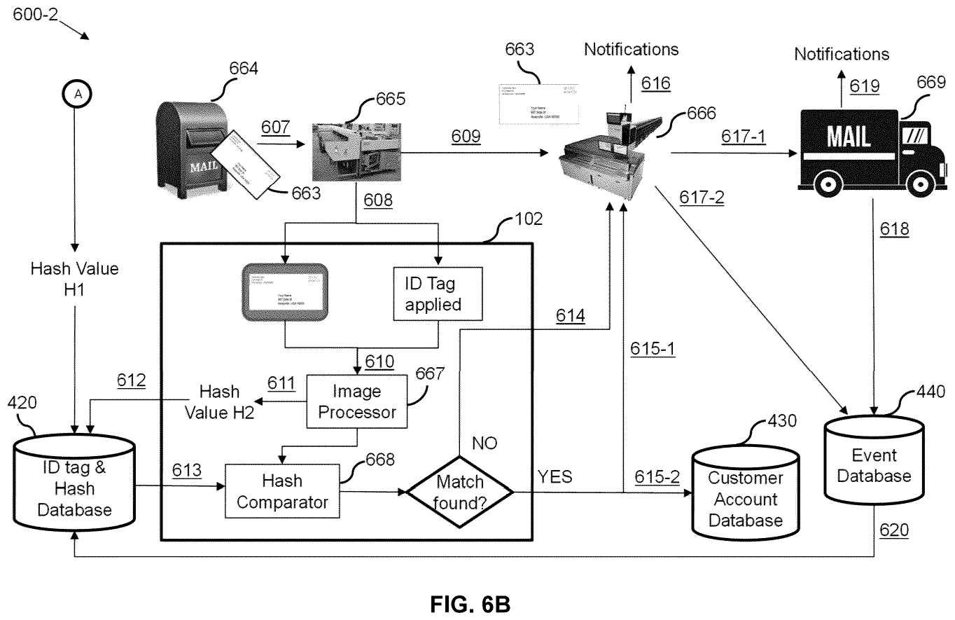

FIGS. 6A and 6B illustrate an exemplary process 600 for tracking a mail piece based on hash values, in accordance with some embodiments of the present teaching. FIG. 6A illustrates a sub-process 600-1 of the process 600, performed at a mobile app of a user device. FIG. 6B illustrates a sub-process 600-2 of the process 600, performed at a delivery or mail service.

In the example shown in FIG. 6A, Customer Bea 661 has a letter 663 to send out using a delivery or mail service. At step 601, Customer Bea 661 has no stamp or does not want to use a stamp for mailing the letter 663.

At step 602, Customer Bea 661 logs into a mobile app on a smartphone 662. In some embodiments, the mobile app is an app associated with a delivery or mail service. In some embodiments, the mobile app is a Hash Tracker app including a function for tracking a mail piece based on hash values. In some embodiments, the smartphone 662 may be replaced by any of the user computing devices 110, 112, 114 as described above.

At step 603, the app instructs Customer Bea 661 to write something specific or unique in the upper right corner, i.e., in the stamp zone, of the letter 663. The purpose of the writing is to increase uniqueness. As such, Customer Bea 661 is instructed or preferred to hand write certain specific or unique characters. In this example, Customer Bea 661 is instructed to write: her initials, a randomly generated number, and the date. This instruction at step 603 is configurable by the app and/or the user. In some embodiments, the writing at step 603 includes any writing or drawing that can alter the picture of the letter 663 in a specific or unique way.

At step 604, the app activates a camera of the smartphone 662 and instructs Customer Bea 661 to take a picture of a front side of the letter 663, including the writing or marking in the stamp zone of the letter 663 (completed in step 603). In some embodiments, Customer Bea 661 is instructed to take the picture while putting the letter 663 in a predetermined orientation, e.g. the same as the orientation of the mail piece 500 in FIG. 5.

At step 605, the app hashes the picture based on a hash function, to generate a hash value H1. In some embodiments, the hash value H1 is a series of characters with a predetermined length, e.g. 128 to 512 bits. In some embodiments, the hash function is based on one of the following algorithms: MD4, MD5, or any other MD series algorithms; SHA-0, SHA-1, SHA-2, SHA-3, or any other SHA series algorithms; BLAKE2, BLAKE3, or any other BLAKE series algorithms; RIPEMD-160; Whirlpool; or any other cryptographic hash algorithms. In some embodiments, the hash function is trained based on machine learning and letter images with various writings. In some embodiments, the length of generate hash value is also determined based on machine learning and updated dynamically based on tracking performance of the disclosed tracking functions. In addition, the app sends the hash value H1 to the mail service, along with a user ID of Customer Bea 661 for later updates and notifications. The hash value H1 and the associated user ID are stored in a database, e.g. the ID tag and hash database 420.

In some embodiments, the mail service checks the hash value H1 for uniqueness. For example, the hash value H1 can be compared with other hash values received by the mail service before, or within a predetermined past time period, to determine uniqueness in the hash values. In some embodiments, the uniqueness can be quickly checked by comparing the hash value H1 with other hash values received by the mail service on the same date. In some embodiments, the uniqueness can be quickly checked by comparing the hash value H1 with hash values previously generated based on mail pieces mailed by Customer Bea 661 herself. If the hash value H1 is determined to be not unique, Customer Bea 661 is instructed to add additional marks in the stamp zone (similar to step 603), and take a new picture of front side of the letter 663 (similar to step 604).

When the hash value of the letter 663 is determined to be unique, the process moves to step 606, where the app instructs Customer Bea 661 to mail the letter 663. As such, Customer Bea 661 puts the letter 663 in a mailbox 664, without using a stamp or going to a postal or delivery office. Customer Bea 661 then waits for delivery status information of the letter 663, which will be received at step 621 as notifications on the smartphone 662 from the mail service. In the meantime, the process moves to the steps in the sub-process 600-2 shown in FIG. 6B.

In the example shown in FIG. 6B, at step 607, the mail service collects, e.g. by a mail carrier, the letter 663 from the mailbox 664; and processes the letter 663, e.g. by a mail handling system 665. In some embodiments, the mail handling system 665 is implemented as the mail handling system 310 in FIG. 3. In some embodiments, the mail handling system 665 processes the letter 663 normally as described above regarding the mail handling system 310, except that any “no postage” decision is temporarily overridden. In some embodiments, the mail handling system 665 can detect handwritings or characters in the stamp zone of the letter 663, to determine that a user account needs to be determined based on picture hash values for charging the mailing of the letter 663. However, in some other embodiments, the mail handling system 665 can determine that detecting no stamp or detecting merely some handwriting or marking in the stamp zone of a letter is to result in a decision of the letter being rejected for lack of appropriate payment to the mail service.

At step 608, the mail handling system 665 lifts an image or takes a picture of the letter 663, and applies an ID tag on the letter 663. This picture of the letter 663 is called a candidate picture, because the mail service does not know the identity of the customer mailing the letter 663 yet. In some embodiments, the candidate picture is taken from the front side of the letter 663; and the ID tag is applied on a side other than the front side (e.g., the back side) of the letter 663. In some embodiments, the ID tag is a bar code sprayed or attached to the back side of the letter 663.

In some embodiments, the candidate picture of the letter 663 is taken by a camera in the mail handling system 665. In some embodiments, the candidate picture of the letter 663 is taken by the mail handling system 665 after the letter 663 is put in a predetermined orientation, e.g. the same as the orientation of the mail piece 500 in FIG. 5. In this case, the mail handling system 665 is implemented as a combination of the mail handling system 310 and the mail orienting system 340 in FIG. 3. The candidate picture and the applied ID tag are associated and sent to the mail tracking device 102, waiting for customer identification and hash comparison results from the mail tracking device 102.

In the meantime, at step 609, the letter 663 is sent to a mail sorting system 666. In some embodiments, the mail sorting system 666 is implemented as the mail sorting system 350 in FIG. 3. In some embodiments, the mail sorting system 666 processes the letter 663 normally as described above regarding the mail sorting system 350, except that it is pending decision and waiting for information from the mail tracking device 102.

At step 610, an image processor 667 receives the ID tag and the associated image or picture from the mail handling system 665. At step 611, the image processor 667 hashes the image based on a hash function, to generate a hash value H2. In some embodiments, the hash function used by the image processor 667 at step 611 is the same as the hash function used by the app at step 605. In some embodiments, the hash value H2 is a series of characters with a predetermined length same as that of the hash value H1. In addition, the image processor 667 links or associates the hash value H2 to the ID tag.

At step 612, the associated ID tag and hash value H2 are stored into a database, e.g. the ID tag and hash database 420. As discussed above, the ID tag and hash database 420 also stores other hash values, including the hash value H1 generated by the app. In some embodiments, the hash value H1 and its associated user ID of Customer Bea 661 are stored into the ID tag and hash database 420 by the server 104 from the app. In some embodiments, each hash value in the ID tag and hash database 420 is generated by applying the same hash function as the one previously used to generate hash value H1, to a respective image of a corresponding mail piece, using a mobile app on a user device of a corresponding user. In some embodiments, each hash value in the ID tag and hash database 420 was generated based on a process similar to the process 600-1, using the same app on the user device of the corresponding user.

In some embodiments, all hash values in the ID tag and hash database 420 and hash values generated by the mail tracking device 102 are generated based on corresponding pictures of mail pieces having a same predetermined orientation when being taken, e.g., the orientation of the mail piece 500 in FIG. 5. In some embodiments, all hash values in the ID tag and hash database 420 and hash values generated by the mail tracking device 102 are generated after an orientation normalization, i.e. after modifying the corresponding pictures to a same predetermined orientation, e.g., the orientation of the mail piece 500 in FIG. 5, to avoid impact to hash value comparison from orientation differences when different pictures are taken. In some embodiments, the orientation normalization includes: determining different zones in a picture of a mail piece by detecting texts and/or stamp in these zones; determining relative locations of these zones on the front side of the mail piece; and modifying or rotating the picture to make these zones match predetermined locations corresponding to the same predetermined orientation. For example, when the picture is rotated such that a stamp zone in a picture matches an upper right location of the same predetermined orientation, the picture would align with the same predetermined orientation, e.g., the orientation of the mail piece 500 in FIG. 5, and be ready to generate a hash value. In some embodiments, all hash values in the ID tag and hash database 420 and hash values generated by the mail tracking device 102 are generated based on corresponding pictures taken in a clear and bright environment. In some embodiments, all hash values in the ID tag and hash database 420 and hash values generated by the mail tracking device 102 are generated based on a brightness normalization, e.g. by considering merely relative brightness of different portions of the corresponding pictures, to avoid impact to hash value comparison from brightness differences across different pictures. With the brightness normalization, an absolute degree of brightness of the picture would not affect the generated hash value. In some similar embodiments, all hash values in the ID tag and hash database 420 and hash values generated by the mail tracking device 102 are generated based on: color normalization to avoid impact to hash value comparison from different colors of different pictures, dimension normalization to avoid impact to hash value comparison from different dimensions of different pictures, and/or shape normalization to avoid impact to hash value comparison from different shapes of different pictures or different mail pieces, etc.

At step 613, the hash value H2 is compared by a hash comparator 668 in the mail tracking device 102 with a plurality of hash values received from the app to find a match. At step 614, where there is no match found, the sort decision at the mail sorting system 666 may be “return to sender” or “short-paid,” as no payment is received for the letter 663. At step 615, where there is a successful match between the hash values, e.g., between the hash value H1 and the hash value H2, two sub-steps 615-1 and 615-2 are performed. At sub-step 615-1, the mail sorting system 666 generate the sort decision as coded and postage paid. In addition, the user ID of Customer Bea 661 is associated with the ID tag of the letter 663. This may be stored at sub-step 615-2, as updated customer account information for Customer Bea 661 in a database, e.g. the customer account database 430. Accordingly, a user account associated with the user ID of Customer Bea 661 is determined, such that the mail service company can charge Customer Bea 661 for delivering the letter 663 based on pre-stored information (e.g., payment methods) associated with the user account.

In some embodiments, each hash value is a numeric value of a fixed length that uniquely identifies a picture; and a match between two hash values at step 615 may be determined based on a comparison between the two numeric values. In some embodiments, each hash value is a string of alphanumeric characters of a fixed length that uniquely identifies a picture; and a match between two hash values at step 615 may be determined based on a character-by-character comparison between the two strings. In some embodiments, it is critical that the hashing algorithm and framing processes used by the mobile device at step 605 and the hashing algorithm and framing processes used by the image processor 667 at the mail service at step 611 are in complete agreement in order to generate compatible and comparable hash results.

In some embodiments, the hash comparator 668 may be replaced by a general image comparator, which can compare two images or pictures to determine whether they match each other. In some embodiments, the image comparison may be performed by the hash comparator 668 on two pictures: the picture taken by the mail handling system 665 and a candidate picture stored in the ID tag and hash database 420. The process 600 would go to step 614 when there is no match, and would go to step 615 when there is a match between the two pictures. In some embodiments, before the image comparison, each of the two pictures to be compared is processed with: orientation normalization, brightness normalization, color normalization, dimension normalization, shape normalization, etc. In some embodiments, the image comparison is performed based on a machine learning model and/or an artificial intelligence (AI) model.

At step 616, Customer Bea 661 is notified of either mail piece received and processed, or no mail received, depending on whether step 614 or step 615 is performed, i.e., depending on whether there is a match found by the hash comparator 668 for the hash value H2. The notifications at step 616 may be received by the app on the smartphone 662.

The step 617 includes two sub-steps 617-1 and 617-2. At sub-step 617-1, the letter 663 is sorted and sent to destination post office. At sub-step 617-2, the event database 440 is updated with delivery events happening on the way of delivering the letter 663, based on the ID tag of the letter 663. At step 618, the letter 663 is delivered by a mail carrier 669, and the event database 440 is further updated with the delivery status of the letter 663, based on the ID tag of the letter 663.

At step 619, Customer Bea 661 is notified of the delivery status of the letter 663. The notifications at step 619 may be received by the app on the smartphone 662. In some embodiments, from step 616 to step 619, the letter 663 is continuously tracked based on its ID tag (which can be read by any mail sorting system or barcode sorter); and Customer Bea 661 is continuously notified with any updated delivery status of the letter 663, based on an association between the user ID of Customer Bea 661 and the ID tag of the letter 663.

Optionally at step 620, some hash values are deleted from the database 420. For example, hash values older than a predetermined time period, e.g. one or two months, are deleted from the database 420.

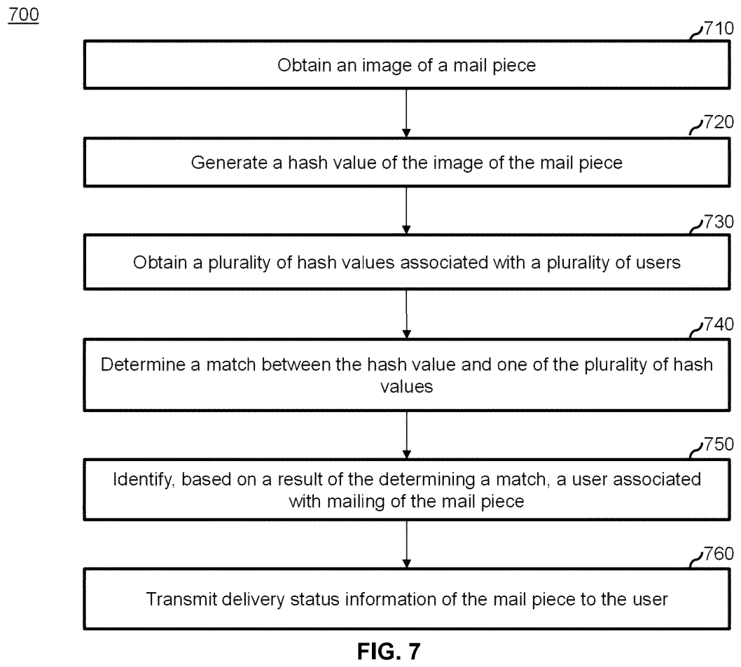

FIG. 7 is a flow chart illustrating an exemplary method 700 for tracking a mail piece, in accordance with some embodiments of the present teaching. In some embodiments, the method 700 can be carried out by one or more systems as described in FIGS. 1-6. Beginning at operation 710, an image of a mail piece is obtained (e.g. by the image processor 667 at step 610). At operation 720, a hash value of the image of the mail piece is generated (e.g. by the image processor 667 at step 611). At operation 730, a plurality of hash values associated with a plurality of users are obtained (e.g. by the hash comparator 668 at step 613). At operation 740, a match is determined between the hash value and one of the plurality of hash values (e.g. by the hash comparator 668 at step 613). At operation 750, a user associated with mailing of the mail piece is identified based on a result of the determining a match (e.g. by the hash comparator 668 at step 615). At operation 960, delivery status information of the mail piece is provided to the user (e.g. during steps 616, 619, 621).

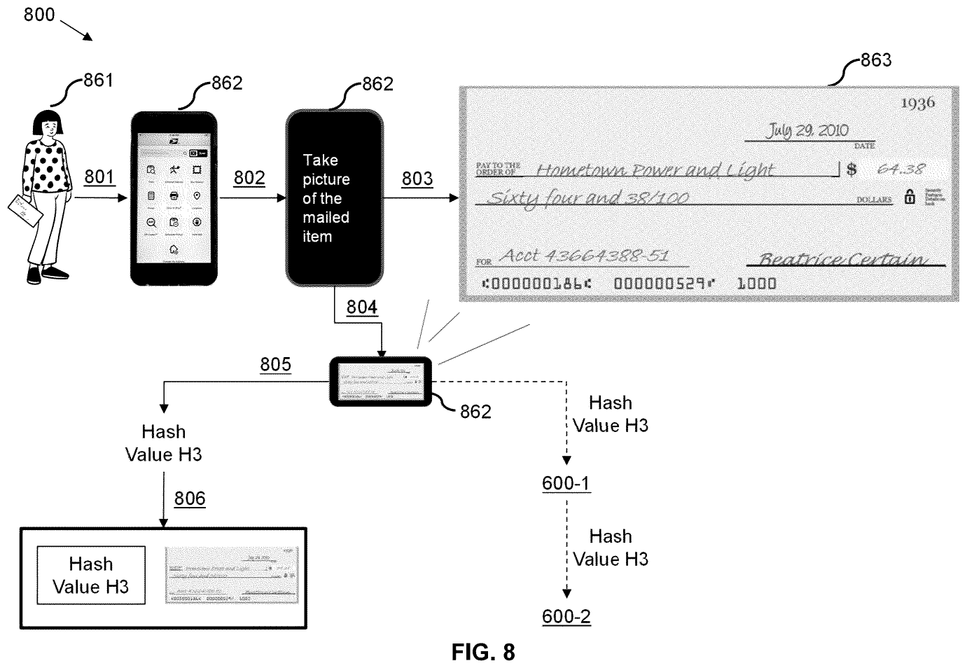

FIG. 8 illustrates an exemplary process 800 for tracking a mailed item based on hash values, in accordance with some embodiments of the present teaching. In some embodiments, the process 800 is performed by a mobile app of a user device and/or devices associated with a delivery or mail service.

In the example shown in FIG. 8, a customer 861 (who may or may not be Customer Bea 661) wants to mail a check 863 to pay her electric bill. At step 801, the customer 861 is worried about a mail theft or altered check, if she mails the check 863 via a mail piece, e.g. in an envelope.

At step 802, the customer 861 logs into a mobile app on a smartphone 862. In some embodiments, the mobile app is an app associated with a delivery or mail service. In some embodiments, the mobile app is a Check Tracker app including a function for tracking a mailed item like a check based on hash values. In some embodiments, the smartphone 862 may be replaced by any of the user computing devices 110, 112, 114 as described above.

At step 803, the app instructs the customer 861 to put the check 863 in a predetermined orientation, e.g. the orientation of the check 863 as shown in FIG. 8. At step 804, the app activates a camera of the smartphone 862 and instructs the customer 861 to take a picture of a front side of the check 863. In some embodiments, the customer 861 is instructed to take the picture of the check 863, while covering some sensitive information e.g. bank account number, on the check 863. Covering the sensitive information is just optional because the picture of the check 863 will only be stored locally on the smartphone 862, without being sent out to the mail service or any server in the cloud.

At step 805, the app hashes the picture based on a hash function, to generate a hash value H3. In some embodiments, the hash value H3 is a series of characters with a predetermined length. In some embodiments, the hash function is trained based on machine learning and sample check images.

At step 806, the app associates the picture with the hash value H3, and stores the associated picture and hash value H3 on the smartphone 862 for future use if needed. In some embodiments, the process 800 stops here. The stored information can be used to provide evidence for filing affidavits or police reports to support some potential alteration claims, protecting interests of the customer 861.

If the customer 861 desires, she could track the status of the envelope containing the check 863. This envelope tracking process would be similar to processes 600-1, 600-2 in FIGS. 6A and 6B, with two exceptions. The first exception is that when the process 600-1 is performed as part of the process 800, the hash value H3 of the check 863 is passed to the Hash Tracker app and linked to the hash value of the envelope hash (e.g. the hash value H1 in FIG. 6A), such that both hash values of the check and the envelop are associated and stored on the smartphone 862. The second exception is that when the process 600-2 is performed as part of the process 800, both hash values (e.g. hash value H3 and hash value H1) are transmitted to the mail service together with the user ID of the customer 861, and are stored in a database, e.g. in the ID tag and hash database 420, in association with the user ID of the customer 861, to enable lookup for future search by the customer 861 or law enforcement. For example, while the mail service does not know the check picture, it does record the hash value of the check picture, where it is extremely difficult or impossible to deduct the check picture from its hash value. But with that record and the check picture stored on the smartphone 862, the customer 861 could later prove that the numbers and characters in the check 863 are accurate to generate the recorded hash value, by re-generating the recorded hash value from the stored picture of the check 863 on the smartphone 862. This can help preventing alteration of numbers on the check 863 after it is mailed out.

In some embodiments, after the hash value H3 and the hash value H1 are both transmitted to the mail service together with the user ID of the customer 861, the mail tracking device 102 may not find a match for the hash value H1 for a long time, e.g. longer than two weeks or a month. In that case, the mail service may send a reminder to the customer 861 via the app or other contact information, indicating that no mail piece, containing the concerned item corresponding to the hash value H3, has been received since the hash values are received.

In some embodiments, the process 800 may be used to track not only check, but also any item mailed with concern, including e.g. bills, receipt, money order, legal documents, any item with critical numerical information, or any item with a high or special value to the customer 861.

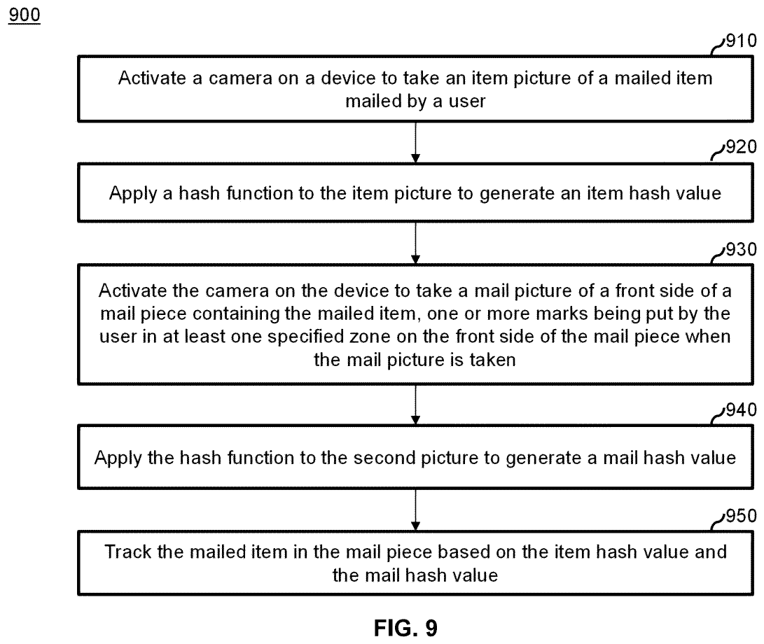

FIG. 9 is a flow chart illustrating an exemplary method 900 for tracking a mailed item, in accordance with various embodiments of the present teaching. In some embodiments, the method 900 can be carried out by one or more systems as described in FIGS. 1-8. Beginning at operation 910, a camera on a device is activated to take an item picture of a mailed item mailed by a user (e.g. by a mobile app on the device at step 804). At operation 920, a hash function is applied to the item picture to generate an item hash value (e.g. by the app on the device at step 805). At operation 930, the camera on the device is activated to take a mail picture of a front side of a mail piece containing the mailed item, one or more marks being put by the user in at least one specified zone on the front side of the mail piece when the mail picture is taken (e.g. by the app on the device at step 604). At operation 940, the hash function is applied to the second picture to generate a mail hash value (e.g. by the app on the device at step 605). The mailed item in the mail piece is tracked at operation 950 based on the item hash value and the mail hash value (e.g. by the app on the device at step 621).

Although the methods described above are with reference to the illustrated flowcharts, it will be appreciated that many other ways of performing the acts associated with the methods can be used. For example, the order of some operations may be changed, and some of the operations described may be optional.

In some embodiments, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

In some embodiments, each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. A method, implemented on one or more computing devices including at least one processor and a non-transitory memory, for tracking a mailed item contained in a mail piece mailed by a user, the method comprising:
capturing, using a camera on a mobile device, an item picture of the mailed item;
generating an item hash value using a hash function on the item picture;
capturing, using the camera on the mobile device, a mail picture of a front side of the mail piece containing the mailed item, wherein one or more marks are put by the user in at least one specified zone on the front side of the mail piece when the mail picture is taken;
generating a mail hash value using the hash function on the mail picture;
transmitting the item hash value, the mail hash value and a user identity (ID) of the user to a mail service computing device associated with a mail service configured for carrying and delivering the mail piece; and
tracking the mailed item in the mail piece by monitoring one or more notifications regarding delivery status information of the mail piece from the mail service computing device, wherein the one or more notifications regarding delivery status information of the mail piece are generated based on (i) one or more comparisons of the item hash value to other item hash values for other mail pieces, (ii) one or more comparisons of the mail hash value to other mail hash values for other mail pieces and (iii) the user ID.

2. The method of claim 1, further comprising:
storing the item hash value and the mail hash value on the mobile device; and
associating the item hash value with the mail hash value, wherein the associated two hash values and the user ID of the user are transmitted to the mail service computing device.

3. The method of claim 2, wherein the mail service computing device is configured to:
check uniqueness of the mail hash value based on hash values in a database associated with the mail service;
store the mail hash value as one of a plurality of hash values when the uniqueness is established; and
transmit a notification to the mobile device when the uniqueness is not established.

4. The method of claim 3, further comprising:
receiving the notification from the mail service computing device;
activating the camera on the mobile device to take an additional mail picture of the front side of the mail piece, wherein additional marks are put on the front side of the mail piece when the additional mail picture is taken; and
applying the hash function to the additional mail picture to generate an additional mail hash value.

5. The method of claim 4, further comprising:
storing the additional mail hash value on the mobile device;
associating the item hash value with the additional mail hash value; and
transmitting, to the mail service computing device, the additional mail hash value and the user ID of the user.

6. The method of claim 2, wherein the mail service computing device is configured to:
collect the mail piece mailed by the user for delivery;
capture, using a camera associated with the mail service computing device, a candidate picture of the front side of the mail piece;
apply the hash function to the candidate picture to generate a candidate hash value;
obtain a plurality of hash values associated with a plurality of users, wherein the plurality of hash values include the mail hash value;
determine a match between the candidate hash value and the mail hash value in the plurality of hash values; and
identify, based on the match, the user who mailed the mail piece.

7. The method of claim 6, wherein the mail service computing device is further configured to:
apply an ID tag on a back side of the mail piece;
associate the ID tag with the candidate picture of the mail piece;
associate the ID tag with the user;
track, based on the ID tag, the mail piece to determine its delivery status information; and
transmit the one or more notifications regarding the delivery status information of the mail piece to the mobile device of the user.

8. The method of claim 6, wherein:
each of the plurality of hash values is generated by applying the hash function to a respective picture of a corresponding mail piece using a user device of a corresponding user; and
the candidate hash value and the plurality of hash values are all generated based on pictures of corresponding mail pieces having a same predetermined orientation.

9. The method of claim 1, wherein the at least one specified zone comprises a stamp zone at an upper right corner of the front side of the mail piece.

10. The method of claim 9, further comprising:
determining that no stamp is attached to the stamp zone;
detecting at least one mark in the stamp zone;
determining a user account of the user; and
charging the user for delivering the mail piece based on pre-stored payment method information associated with the user account.

11. A non-transitory computer readable medium having instructions stored thereon for tracking a mailed item contained in a mail piece mailed by a user, wherein the instructions, when executed by at least one processor, cause the at least one processor to perform operations comprising:
capturing, using a camera on a mobile device, an item picture of the mailed item;
generating an item hash value using a hash function on the item picture;
capturing, using the camera on the mobile device, a mail picture of a front side of the mail piece containing the mailed item, wherein one or more marks are put by the user in at least one specified zone on the front side of the mail piece when the mail picture is taken;
generating a mail hash value using the hash function on the mail picture;
transmitting the item hash value, the mail hash value and a user identity (ID) of the user to a mail service computing device associated with a mail service configured for carrying and delivering the mail piece; and
tracking the mailed item in the mail piece by monitoring one or more notifications regarding delivery status information of the mail piece from the mail service computing device, wherein the one or more notifications regarding delivery status information of the mail piece are generated based on (i) one or more comparisons of the item hash value to other item hash values for other mail pieces, (ii) one or more comparisons of the mail hash value to other mail hash values for other mail pieces and (iii) the user ID.

12. The non-transitory computer readable medium of claim 11, wherein the instructions, when executed by the at least one processor, further cause the mobile device to perform operations comprising:
storing the item hash value and the mail hash value on the mobile device; and
associating the item hash value with the mail hash value, wherein the associated two hash values and the user ID of the user are transmitted to the mail service computing device.

13. The non-transitory computer readable medium of claim 12, wherein the mail service computing device is configured to:
check uniqueness of the mail hash value based on hash values in a database associated with the mail service;
store the mail hash value as one of a plurality of hash values when the uniqueness is established; and
transmit a notification to the mobile device when the uniqueness is not established.

14. The non-transitory computer readable medium of claim 13, wherein the instructions, when executed by the at least one processor, further cause the mobile device to perform operations comprising:
receiving the notification from the mail service computing device;
activating the camera on the mobile device to take an additional mail picture of the front side of the mail piece, wherein additional marks are put on the front side of the mail piece when the additional mail picture is taken; and
applying the hash function to the additional mail picture to generate an additional mail hash value.

15. The non-transitory computer readable medium of claim 14, wherein the instructions, when executed by the at least one processor, further cause the mobile device to perform operations comprising:
storing the additional mail hash value on the mobile device;
associating the item hash value with the additional mail hash value; and
transmitting, to the mail service computing device, the additional mail hash value and the user ID of the user.

16. The non-transitory computer readable medium of claim 12, wherein the mail service computing device is configured to:
collect the mail piece mailed by the user for delivery;
capture, using a camera associated with the mail service computing device, a candidate picture of the front side of the mail piece;
apply the hash function to the candidate picture to generate a candidate hash value;
obtain a plurality of hash values associated with a plurality of users, wherein the plurality of hash values include the mail hash value;
determine a match between the candidate hash value and the mail hash value in the plurality of hash values; and
identify, based on the match, the user who mailed the mail piece.

17. The non-transitory computer readable medium of claim 16, wherein the mail service computing device is further configured to:
apply an ID tag on a back side of the mail piece;
associate the ID tag with the candidate picture of the mail piece;
associate the ID tag with the user;
track, based on the ID tag, the mail piece to determine its delivery status information; and
transmit the one or more notifications regarding the delivery status information of the mail piece to the mobile device of the user.

18. The non-transitory computer readable medium of claim 16, wherein:
each of the plurality of hash values is generated by applying the hash function to a respective picture of a corresponding mail piece using a user device of a corresponding user; and
the candidate hash value and the plurality of hash values are all generated based on pictures of corresponding mail pieces having a same predetermined orientation.

19. The non-transitory computer readable medium of claim 11, wherein:
the at least one specified zone comprises a stamp zone at an upper right corner of the front side of the mail piece; and
the instructions, when executed by the at least one processor, further cause the mobile device to perform operations comprising:
determining that no stamp is attached to the stamp zone,
detecting at least one mark in the stamp zone,
determining a user account of the user, and
charging the user for delivering the mail piece based on pre-stored payment method information associated with the user account.

20. A mobile device for tracking a mailed item contained in a mail piece mailed by a user, the mobile device comprising:
a non-transitory memory having instructions stored thereon; and
at least one processor operatively coupled to the non-transitory memory, and configured to read the instructions to:
capture, using a camera on the mobile device, an item picture of the mailed item,
generate an item hash value using a hash function on the item picture,
capture, using the camera on the mobile device, a mail picture of a front side of the mail piece containing the mailed item, wherein one or more marks are put by the user in at least one specified zone on the front side of the mail piece when the mail picture is taken,
generate a mail hash value using the hash function on the mail picture,
transmit the item hash value, the mail hash value and a user identity (ID) of the user to a mail service computing device associated with a mail service configured for carrying and delivering the mail piece, and
track the mailed item in the mail piece by monitoring one or more notifications regarding delivery status information of the mail piece from the mail service computing device, wherein the one or more notifications regarding delivery status information of the mail piece are generated based on (i) one or more comparisons of the item hash value to other item hash values for other mail pieces, (ii) one or more comparisons of the mail hash value to other mail hash values for other mail pieces and (iii) the user ID.
